(19) United States
(12) Patent Application Publication
(10) Pub. No.: US 2024/0229501 A9
(43) Pub. Date: Jul. 11, 2024

(54) QUICK MOUNTABLE ASSEMBLY FOR HANDLE, HANDLE ASSEMBLY, AND METHOD OF MOUNTING THE SAME

(71) Applicant: XIAMEN LOTA INTERNATIONAL CO., LTD., Xiamen (CN)

(72) Inventors: Shuanglin Bai, Xiamen (CN); Liming Ye, Xiamen (CN); Chunzhi Liu, Xiamen (CN); Chuanbao Zhu, Xiamen (CN)

(73) Assignee: XIAMEN LOTA INTERNATIONAL CO., LTD., Xiamen (CN)

(21) Appl. No.: 18/382,424

(22) Filed: Oct. 20, 2023

(30) Foreign Application Priority Data
Oct. 21, 2022 (CN) 2022112909166
Oct. 21, 2022 (CN) 2022227762526

(51) Int. Cl. E05B 1/00

(52) U.S. Cl. CPC E05B 1/00

(57) ABSTRACT

The disclosure presents a quick mountable assembly for handle, a handle assembly, and a method of mounting the same. The quick mountable assembly for handle includes a tube having a first peripheral section and a second peripheral section arranged in a circumferential direction. The second peripheral section includes convex threads compared to the surface of the first peripheral section. The assembly further includes a nut having a first inner wall section and a second inner wall section arranged in a circumferential direction. The second inner wall section has convex threads compared to the surface of the first inner wall section. The nut has a first engagement position in which the second inner wall section aligned to the first peripheral section of the tube and a second engagement position in which the second inner wall section screwed to the second peripheral section of the tube.

### TECHNICAL FIELD

The present disclosure relates to bathroom equipment, in particular to a quick mountable assembly for handle in bathroom equipment, a handle assembly and a method of installing the same.

### BACKGROUND

When installing a handle of the bathroom equipment, the usual method is to sleeve a nut onto a threaded tube and screw it tightly. The nut is a standard part, which has advantages of lower cost and firmer installation. However, the known installation method of screwing the nut onto the threaded pipe has the defects that the threads cannot be aligned with easily, and quick release and installation cannot be achieved, resulting time waste.

Therefore, there is a need in the industry to improve the existing handle installation method and installation structure so as to increase the installation efficiency.

### SUMMARY

The present disclosure provides a quick mountable assembly for handle, which could solve at least some of the above-identified technical problems.

The present disclosure also provides a handle assembly which utilizes the above improved quick mountable assembly for the handle.

The present disclosure also provides a method for installing the above improved handle assembly.

According to one aspect of the present disclosure, a quick mountable assembly for handle is provided, including a tube having a first peripheral section and a second peripheral section being arranged in a circumferential direction, wherein the second peripheral section is provided with threads that are convex compared to the surface of the first peripheral section. The assembly further includes a nut having a first inner wall section and a second inner wall section arranged in a circumferential direction, wherein the second inner wall section is provided with threads that are convex compared to the surface of the first inner wall section. The nut has a first engagement position at which the second inner wall section can be aligned with the first peripheral section of the tube and a second engagement position in which the second inner wall section can be screwed to the second peripheral section of the tube. The nut is capable of moving between the first engagement position and the second engagement position.

According to the quick mountable assembly for handle of the present disclosure, the nut could be switched between the first engagement position and the second engagement position. In the first engagement position, the nut could be quickly sleeved onto a predetermined position on the tube (e.g., the root of the tube near the mounting table) by means of axial movement, and thereafter the nut could be rotated to switch to the second engagement position and lock the tube. Conventionally, the nut may be screwed from one end of the tube all the way to the other end of the tube in a slow and spiral process. The quick mountable assembly for handle of the present disclosure can spilt the movement of the nut with respect to the tube into exclusively axial movement and rotational movement thereafter, which could significantly speed up the installation of the nut onto the tube and have simple construction. The threads (screw tooth) of both the nut and the tube could be standard threads that may be machined by a cutting process without increasing the cost.

In some embodiments, the first peripheral section of the tube is constructed as a smooth section without surface textures and is adapted to accommodate the convex threads of the second inner wall section of the nut.

In some embodiments, the first inner wall section of the nut is constructed as a smooth section without surface textures and is adapted to accommodate the convex threads of the second peripheral section of the tube.

In some embodiments, a radial projection is provided at the intersection of the first inner wall section and the second inner wall section of the nut.

In some embodiments, a radial projection is provided at the intersection of the first peripheral section and the second peripheral section of the tube.

In some embodiments, a pin is inserted through the nut or the tube, wherein the portion of the pin protruding from the inner wall of the nut or the outer wall of the tube is constructed as the radial projection.

In some embodiments, the nut has a pair of radial lugs arranged symmetrically to the center, wherein fasteners are inserted through the lugs.

In some embodiments, the fastener is a fastening screw.

According to another aspect of the present disclosure, there is provided a handle assembly including a handle and a quick mountable assembly for handle as previously described, wherein the handle is connected to the tube.

According to a further aspect of the present disclosure, there is provided a method for mounting a handle assembly. The method includes providing the handle assembly as previously described, inserting the tube into a mounting table; sleeving the nut to the tube in the first engagement position from the side of the mounting table facing away to the handle, moving the nut in the first engagement position close to the mounting table along the axial direction of the tube, rotating the nut to moves the nut to the second engagement position, and fastening the nut to the mounting table.

Other features and advantages of the present disclosure may in part be apparent to those skilled in the art upon reading this application, and another part may be described in conjunction with the accompanying drawings in the specific embodiments below.

### BRIEF DESCRIPTION OF THE DRAWINGS

Hereinafter, embodiments of the present disclosure are described in detail in connection with the accompanying drawings.

FIG. 1 is a schematic diagram of a handle assembly according to an embodiment of the present disclosure.

FIG. 2 is an exploded view of a handle assembly according to an embodiment of the present disclosure.

FIG. 3 is a schematic diagram of a handle assembly according to an embodiment of the present disclosure, wherein the handle assembly is adaptable to two types of nuts.

FIGS. 4, 7 and 9 are schematic diagrams of the steps for assembling the handle assembly according to embodiments of the present disclosure.

FIG. 5 is a schematic diagram of the nut to be sleeved onto the tube in the step shown in FIG. 4.

FIG. 6 is a schematic cross-sectional view of the assembly in the step shown in FIG. 4.

FIG. 8 is a schematic cross-sectional view of the assembly in the step shown in FIG. 7.

1—handle assembly; 2—handle; 3—tube; 31—first peripheral section; 32—second peripheral section; 4—nut; 41—first inner wall section; 42—second inner wall section; 43—lug; 44—fastener; 45—pin; 46—radial projection; 5—mounting table; 6—washer.

### DETAILED DESCRIPTION OF THE DISCLOSURE

The schematic embodiments of the quick mountable assembly for handle, the handle assembly and the method of installing the same disclosed herein are described in detail with reference to the accompanying drawings. Although the drawings are provided to present some embodiments of the disclosure, the drawings need not be drawn to the dimensions of the specific embodiment and certain features may be enlarged, removed or locally cut to better illustrate and explain the disclosure of the disclosure. Some of the components in the accompanying drawings can be positioned according to actual needs without affecting the technical effects. The phrases “in Fig.”, “in Figs.” or similar terms appeared in the specification need not refer to all of the accompanying drawings or examples.

Certain directional terms used hereinafter to describe the drawings, such as “inside”, “outside”, “above”, “below” and other directional terms, may be understood to have their normal meanings and to refer to those directions involved in a normal view of the accompanying drawings. Unless otherwise indicated, the directional terms described in this specification follow substantially the conventional directions understood by those skilled in the art.

In the present disclosure, the terms “first”, “the first”, “second”, “the second” and similar terms do not indicate any order, number or importance, but are used to distinguish one component from the others.

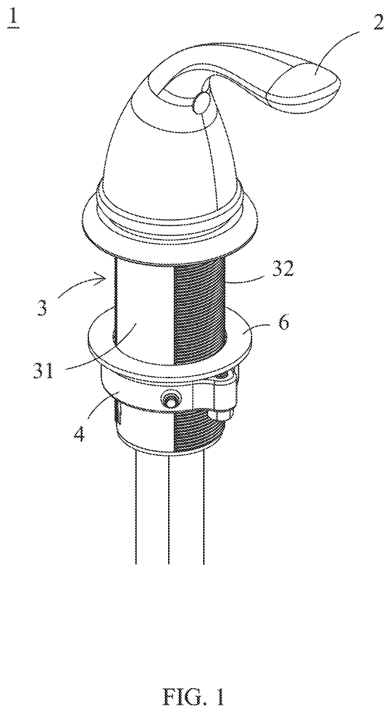

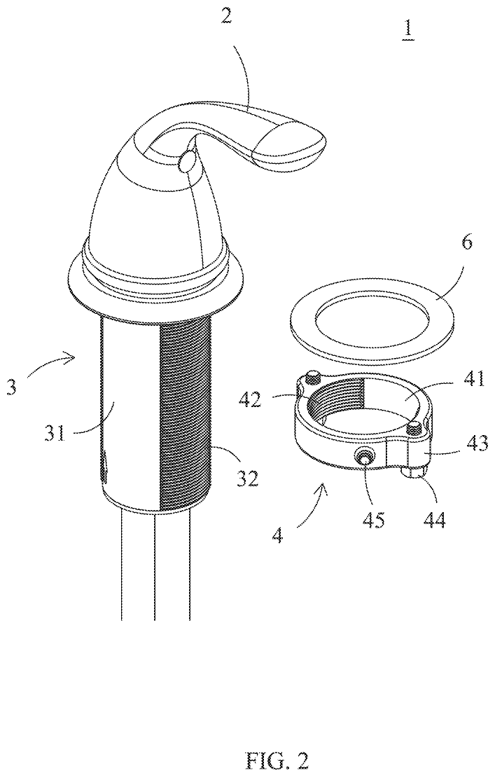

FIGS. 1 and 2 exemplarily illustrate a handle assembly 1 according to the present disclosure, wherein the handle assembly 1 includes a handle 2 and a quick mountable assembly for handle attached to the handle 2. The quick mountable assembly for handle is simple in construction and easy to process, and the efficiency of the installation and removal of the handle can be improved effectively.

As shown in FIG. 2, the quick mountable assembly for handle includes a tube 3 and a nut 4, wherein the tube 3 is attached to the handle 2, the nut 4 could be sleeved onto and threadedly engaged with the tube 3. In the illustrated embodiment, multiple sections in different configurations are formed on the periphery of the tube 3, including a first peripheral section 31 and a second peripheral section 32, wherein the first peripheral section 31 and the second peripheral section 32 are arranged along the circumference of the tube 3 and adjacent to each other. The first peripheral section 31 can be constructed as a smooth section without surface texture, while the second peripheral section 32 can be constructed with threads (screw teeth), such that the second peripheral section 32 can be convex relative to the surface of the first peripheral section 31, while the first peripheral section 31 can be concave relative to the second peripheral section 32 and form an arcuate groove extending along the outer circumference of the tube 3.

It may be noted that “without surface texture” here means that no obvious concave and convex threads (screw teeth) structure can be formed on the entire surface of the first peripheral section as the second peripheral section, and the surface of the first peripheral section as a whole is substantially lie on the circumference of the same radius. However, it is not excluded that the surface of the first peripheral section can be printed with, for example, indication symbols (such as arrows for indicating the installation direction, etc.) or trademark logos, or that the first peripheral section is locally engraved with such indication symbols or trademark logos, which take up a small area of the first peripheral section and do not affect the smooth configuration of the first peripheral section almost in view of visuals and functions.

In one embodiment, one first peripheral section 31 and one second peripheral section 32 are formed on the outer periphery of the tube 3, and the first peripheral section 31 extends 180° along the outer periphery of the tube 3, and the second peripheral section 32 extends 180° along the outer periphery of the tube 3. In another embodiment, two first peripheral sections 31 and two second peripheral sections 32 are formed on the outer periphery of the tube 3, wherein each first peripheral section 31 extends 90° along the outer periphery of the tube 3, and each second peripheral section 32 extends 90° along the outer periphery of the tube 3, and each first peripheral section 31/second peripheral section 32 being located between two adjacent second peripheral sections 32/first peripheral sections 31. In other embodiments, the extension degrees of the first peripheral section 31 and the second peripheral section 32 along the periphery of the tube 3 can be varied as desired, as long as at least one first peripheral section and at least one second peripheral section are present at least on the periphery of the tube 3 and adjacent to each other.

The nut 4 is adapted to be sleeved onto the tube 3 and threadedly engage with the tube 3. As shown in FIG. 2, multiple sections in different configurations can be formed on the inner periphery of the nut 4, including a first inner wall section 41 and a second inner wall section 42, wherein the first inner wall section 41 and the second inner wall section 42 are arranged along the circumference of the nut 4 and adjacent to each other. The first inner wall section 41 is constructed as a smooth section without surface texture, while the second inner wall section 42 is constructed with threads (screw tooth) which could be threadedly engaged with the threads (screw tooth) of the second peripheral section 32 of the tube 3. The first inner wall section 41 can be concave relative to the second inner wall section 42 and form an arcuate groove extending along the inner circumference of the nut 4, while the second inner wall segment 42 can be convex relative to the first inner wall segment 41.

It may be noted that “without surface texture” here means that no obvious concave and convex threads (screw teeth) structure can be formed on the entire surface of the first inner wall section as the second inner wall section, and the surface of the first inner wall section as a whole is substantially lie on the circumference of the same radius. However, it is not excluded that the surface of the first inner wall section is printed with, for example, indication symbols (such as arrows for indicating the installation direction, etc.) or trademark logos, or that the first inner wall section is locally engraved with such indication symbols or trademark logos, which take up a small area of the first inner wall section and do not affect the smooth configuration of the first inner wall section almost in view of visuals and functions.

The numbers of the first inner wall sections 41 and the second inner wall sections 42 of the nut 4 and the degrees they each extends along the inner circumference of the nut are adapted to the numbers and the extension degrees of first peripheral sections 31 and second peripheral sections 32 of the tube 3. For example, in embodiments where tube 3 has one first peripheral section 31 and one second peripheral section 32 each extending 180°, the one first inner wall section 41 of the nut 4 extends 180° and the one second inner wall section 42 of the nut 4 extends 180°. In embodiments where the tube 3 has two first peripheral sections 31 and two second peripheral sections 32 each extending 90°, the two inner wall sections 41 of the nut 4 each extend 90° and the two second inner wall sections 42 each extend 90°. Regardless of the arrangements of the first and second peripheral sections of the tube 3 and the first and second inner wall sections of the nut 4, as long as the first peripheral section could accommodate the convex threads (screw tooth) of the second inner wall section, while the first inner wall section could accommodate the convex threads (screw tooth) of the second peripheral section.

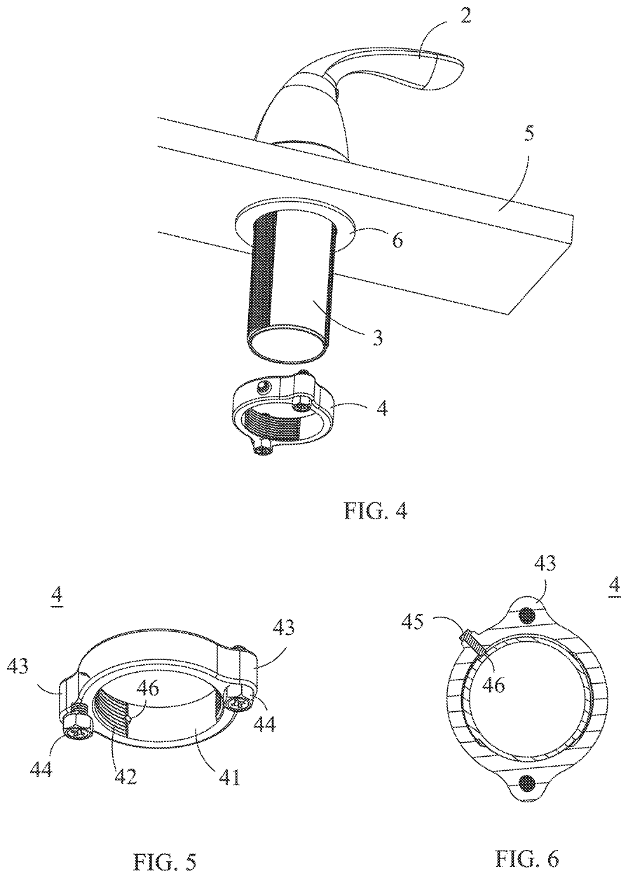

At the inner circumference of the nut 4, a radial projection 46 is formed at the intersection of the first inner wall section 41 and the second inner wall section 42 (shown in FIG. 5). The radial projection acts as a stopper defining the position of the threads (screw teeth) of the second inner wall section 42 and facilitate to screw the nut 4 onto the tube 3 or detach the nut 4 from the tube 3 quickly. In one embodiment, the radial projection 46 includes a portion of the pin 45 protruding from the inner wall surface of the nut 4, and the pin is screwed onto the nut 4. In another embodiment, the radial projection 46 includes a projection formed integrally on the inner wall surface of the nut 4.

In an embodiment not shown, the radial projection may be formed at the intersection of the first peripheral section 31 and the second peripheral section 32 of the tube 3 as a stopper defining the location of the threads (screw teeth) of the second peripheral section 32. In one embodiment, the radial projection includes the portion of the pin protruding from the outer wall surface of the tube 3, and the pin is screwed to the tube. In another embodiment, the radial projection includes a projection formed integrally on the outer wall surface of the tube 3.

A pair of radially protruding lugs 43 can be formed on outer periphery of the nut 4 and designed to be symmetrical with respect to the center of the nut 4. A movable fastener 44, such as a fastening screw, is threaded on each of the lugs 43.

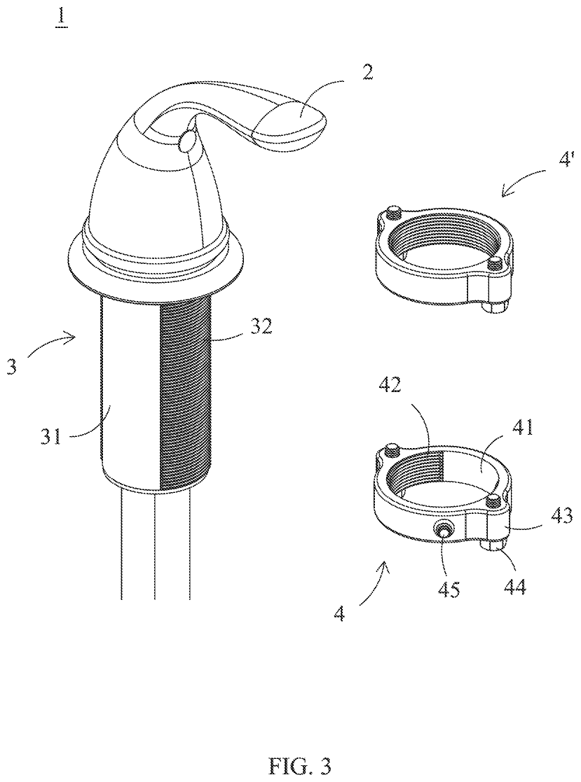

While the tube 3 according to the present disclosure is suitable for cooperating with the nut including a first inner wall section and a second inner wall section as described above to achieve the quick disassembly of the handle, it may be understood by those skilled in the art that such a tube 3 could also be used with a conventional nut 4′ having a full turn of internal threads to achieve conventional handle installation, as shown in FIG. 3.

The method for mounting the above handle assembly 1 is described in detail below in conjunction with FIGS. 4 to 9.

As shown in FIG. 4, the tube 3 connected with the handle 2 is inserted into the mounting table 5, and then the washer 6 is sleeved onto the tube 3 from a side of the mounting table 5 facing away from the handle 2.

By adapting the orientation of the nut 4 with respect to the tube 3 on side of the mounting table 5 facing away from the handle 2, the first inner wall section 41 of the nut 4 can be aligned with the second peripheral section 32 of the tube 3 and the second inner wall section 42 of the nut 4 can be aligned with the first peripheral section 31 of the tube 3. At this point, the nut 4 is in the first engagement position. As shown in FIG. 5, the fastener 44 could be adjusted to the end near the mounting table 5, but not protruded from the lug 43 of the nut 4 or slightly protruded from the lug 43.

By axially pushing the oriented nut 4 from the end of the tube 3 away from the mounting table 5 toward the mounting table 5 along the tube 3, the nut 4 can be moved closer to the mounting table 5 until the nut 4 can be tightly rested against the washer 6, at which point the threads (screw teeth) of the second peripheral section 32 of the tube 3 can be accommodated in the first inner wall section 41 of the nut 4, and the threads (screw teeth) of the second inner wall section 42 of the nut 4 can be accommodated in the first peripheral section 31 of the tube 3. The way of sleeving the nut 4 onto the tube 3 could be more easily understood with reference to FIG. 6.

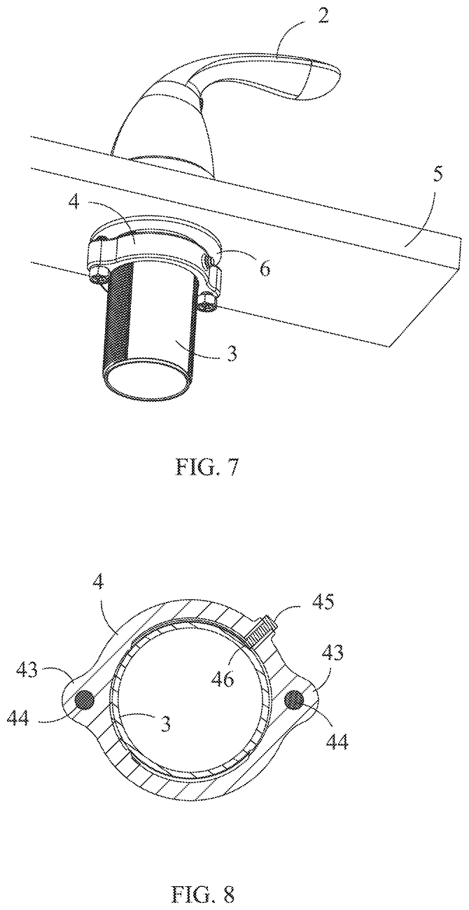

Referring to FIGS. 7 and 8, the nut 4 is then rotated to screw the second inner wall section 42 of the nut 4 to the second peripheral section 32 of the tube 3, at which point the first inner wall section 41 of the nut 4 can be aligned with the first peripheral section 31 of the tube 3, thereby the nut 4 can be moved into a second engagement position. During the rotation of the nut 4, once the radial projection 46 of the nut touches the threads (screw teeth) of the second peripheral section 32 of the tube 3, it means that the nut 4 is rotated into place relative to the tubing 3. The operator could clearly feel that the nut 4 is blocked by the threads (threads) of the tube 3 during this process, and could adjust the position of the nut on the tube by feel alone without visual inspection.

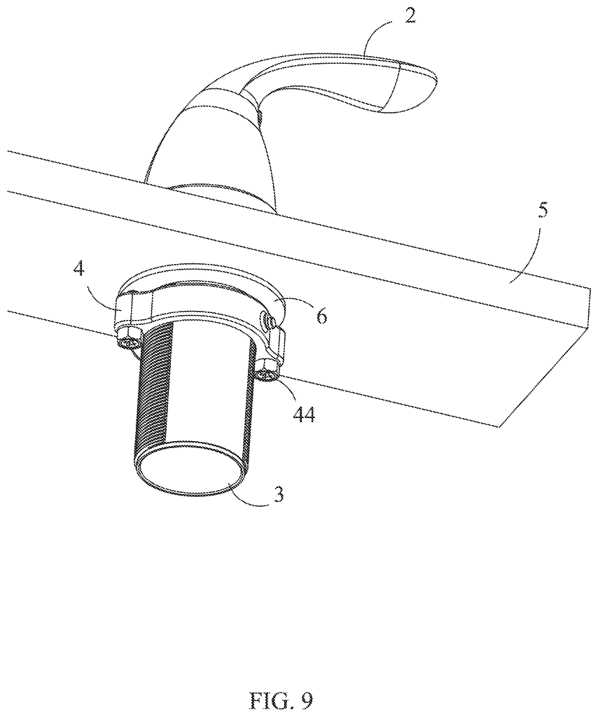

Referring to FIG. 9, once felt that the nut 4 is arranged into place relative to the tube 3, the fastener could be moved (for example, tightening the retaining screw) so as to be pressed against the washer 6, such that installation of nut 4 on tube 3 can be completed.

When removing nut 4, the preceding steps can be just performed in reverse.

It may be understood that although the specification is described in terms of individual embodiments, not each embodiment contains one separate technical solution. The specification is described in this manner for the sake of clarity. A person skilled in the art may consider the specification as a whole. The technical solutions in each embodiment may also be suitably combined to form other embodiments that can be understood by those skilled in the art.

The foregoing are schematic and specific embodiments of the disclosure and are not intended to limit the scope of the disclosure. Any equivalent changes, modifications and combinations made by any person skilled in the art, without departing from the conception and principles of the present disclosure, shall fall within the scope of protection of the present disclosure.

1. A quick mountable assembly for handle, comprises:
a tube comprising a first peripheral section and a second peripheral section arranged in a circumferential direction, wherein the second peripheral section is provided with threads that are convex compared to the surface of the first peripheral section;
a nut comprising a first inner wall section and a second inner wall section being arranged in a circumferential direction, wherein the second inner wall section is provided with threads that are convex compared to the surface of the first inner wall section;
wherein the nut comprising a first engagement position at which the second inner wall section is aligned with the first peripheral section of the tube and a second engagement position in which the second inner wall section is screwed to the second peripheral section of the tube, and the nut is movable between the first engagement position and the second engagement position.

2. The quick mountable assembly for handle according to claim 1, wherein the first peripheral section of the tube is constructed as a smooth section without surface textures and is adapted to accommodate the convex threads of the second inner wall section of the nut.

3. The quick mountable assembly for handle according to claim 1, wherein the first inner wall section of the nut is constructed as a smooth section without surface textures and is adapted to accommodate the convex threads of the second peripheral section of the tube.

4. The quick mountable assembly for handle according to claim 1, wherein at the intersection of the first inner wall section and the second inner wall section of the nut is provided with a radial projection.

5. The quick mountable assembly for handle according to claim 1, wherein at the intersection of the first peripheral section and the second peripheral section of the tube is provided with a radial projection.

6. The quick mountable assembly for handle according to claim 4, wherein a pin is inserted through the nut or the tube, wherein a portion of the pin protruding from one of the inner wall of the nut or the outer wall of the tube is constructed as the radial projection.

7. The quick mountable assembly for handle according to claim 1, wherein the nut comprises a pair of radial lugs arranged symmetrically to the center, wherein fasteners are inserted through the lugs.

8. The quick mountable assembly for handle according to claim 7, wherein the fastener is a fastening screw.

9. A handle assembly, wherein comprising:
handle; and
a quick mountable assembly for handle of claim 1;
wherein the handle is connected to the tube.

10. A method of mounting a handle assembly, comprises:
providing the handle assembly of claim 9;
inserting the tube into a mounting table;
sleeving the nut to the tube in the first engagement position from a side of the mounting table facing away from the handle;
moving the nut in the first engagement position close to the mounting table along the axial direction of the tube;
rotating the nut to move the nut to the second engagement position; and
fastening the nut to the mounting table.

11. The quick mountable assembly for handle according to claim 5, wherein a pin is inserted through the nut or the tube, wherein a portion of the pin protruding from one of the inner wall of the nut or the outer wall of the tube is constructed as the radial projection.
